(19) United States
(12) Patent Application Publication
(10) Pub. No.: US 2012/0116711 A1
(43) Pub. Date: May 10, 2012

(54) Portable celestial compass

(75) Inventors: Donald Bruns, San Diego, CA (US); Timothy Brinkley, San Diego, CA (US)

(73) Assignee: Trex Enterprises Corp.

(21) Appl. No.: 12/283,785

(22) Filed: Sep. 15, 2008

Related U.S. Application Data
(60) Provisional application No. 60/993,813, filed on Sep. 13, 2007.
(60) Provisional application No. 61/010,372, filed on Jan. 7, 2008.

(51) Int. Cl. G01C 17/34; G06F 15/00

(52) U.S. Cl. 702/150

(57) ABSTRACT

A portable celestial compass (PCC) that provides a new multi-functional capability for high precision target localization. The battery-powered PCC is built around US Army's M-25 stabilized binocular and includes a miniature eye-safe laser range finder, a gyro stabilized binocular, a 3-axis tilt compensated digital compass, and a built-in specialized chip with star catalog and software for target AZ/EL determination and sight reduction. A gyro stabilized binocular rejects up to 98% of image motion caused by hand tremor and platform vibration. Laser rangefinder has the accuracy of ±2 m at 5 km range. The PCC uses celestial objects as absolute references for target azimuth and elevation determination. The azimuth and elevation accuracy is 2 mrad, or 10 m at 5 km range, which is by a factor of up to 5 better than that for a magnetic compass.

### FEDERAL SUPPORTED RESEARCH

The present invention was made in the course of work under contract number FA9451-05-C-0019 with the United States Air Force and the United States Government had rights in the invention.

### CROSS REFERENCE TO RELATED APPLICATIONS

This application claims the benefit of Provisional Patent Application Ser. No. 60/993,813, Hand Held Compass, filed Sep. 13, 2007 and Ser. No. 61/010,372 True North Module filed Jan. 7, 2008.

### FIELD OF INVENTION

The present invention relates to directional instruments and especially to celestial compasses.

### BACKGROUND OF THE INVENTION

The accuracy of current and future fire support systems strongly depends on the errors in target coordinates called Target Localization Error (TLE). In order to reduce collateral damage and improve target lethality, a TLE on the order, or less than, 10 meters at 5 km range is required. Current target localization technology does not meet this requirement. The main source of error is a magnetic compass. Commonly a ground-based observer determines target coordinates using a laser rangefinder, GPS receiver, and azimuth-measuring device (magnetic compass). Measurement error of a magnetic compass typically is 5-10 milliradians. This corresponds to the TLE of 25-50 meters at a 5 km range.

The second limitation of the current technology is the limited accuracy of the range measurements using handheld laser range finder. The accuracy of a handheld sensor is degraded by the jitter associated hand tremor of the human operator and platform vibration. The operator-induced jitter makes it extremely difficult, at ranges of a few kilometers and longer, to insure that the laser spot is located at the actual target rather than at a different target entirely.

### SUMMARY OF THE INVENTION

The present invention overcomes limitations of the current technology by using celestial objects as the absolute azimuth and elevation references. A preferred embodiment is a Portable celestial compass (PCC). With the use of celestial measurements, the PCC reduces the TLE down to 2 mrad, or 10 m at 5 km range. The PCC uses a miniature eye-safe laser rangefinder integrated with the US Army's M-25 stabilized binoculars. This integrated sensor allows Applicants to take advantage of the line of sight stabilization provided by the binocular system to eliminate movement and jitter of the laser beam.

The basic concept of the PCS is to determine the absolute azimuth pointing of the laser range finder binoculars based on measurements of sun position, time, and geo-location. In a preferred embodiment hardware mounted on the binoculars consists of a 180 degree fisheye lens, an ND filter, a USB camera, and a MEMS 2-axis inclinometer. The camera and inclinometer are linked to a laptop computer which is used to record raw data (images, inclinometer readings) and provide “real” time calculations. Time is provided by synchronizing the laptop computer to NIST Internet time using NIST Windows XP software (performed once per day). Geo-location is provided by GPS (several independent measurements). A laser rangefinder integrated with M-25 binoculars, allows the observer to measure the target range. By using celestial measurements, the PCS determines the target azimuth and elevation with a high degree of accuracy. Thus, the observer determines target coordinates (range, azimuth, and elevation) with respect to his own GPS coordinates. In addition, when GPS is jammed and not available, the PCS determines the observer geo-position (longitude and latitude) based on star measurements. Thus, the PCS provides a new multi functional capability for target localization, as well as observer geo-position determination independent of GPS. The PCS significantly increases the accuracy of target coordinate determination and thus increases the utility of the targeting system.

### DETAILED DESCRIPTION OF PREFERRED EMBODIMENTS

Preferred embodiments of the present invention can be described by reference to the figures. The PCS is built around M25 stabilized binoculars that have 14-power optics that allows an observer to identify targets and assess battle damage at extended ranges. The M25 is stabilized by a precision miniature gyroscope mounted on a gimbaled platform in the middle of the optical pathway. A gyro stabilized binocular rejects up to 98% of image motion caused by hand tremor and platform vibration. It has a 14× magnification, field of view of 4.3 degrees, and stabilization freedom of ±8 degree.

A laser range finder uses a miniature eye safe laser, which is capable of sending a beam out to 5 km and providing good signal-to-noise ratio without placing a high burden on the power supply. An integration of the range finder with a stabilized binocular provides beam stabilization and eliminates beam jitter. The laser rangefinder has an accuracy of ±2 m at 5 km range.

The PCC also includes a built-in specialized chip with star catalog and software for target AZ/EL determination and sight reduction software. The PCC uses celestial objects (the sun or moon or bright stars or planets) with known position as absolute references for target azimuth and elevation measurements and observer geo-position determination. It uses celestial measurements in conjunction with 3-axis digital compass for target coordinates determination. The azimuth and elevation accuracy is 2 mrad. The accuracy of observer longitude and latitude determination depends on the number of celestial measurements.

In summary, the PCC provides a new multi-functional capability for high precision target localization and performs the following tasks:
Stabilizes the line-of sight for reliable target identification;
Measures the target range with an accuracy of ±2 m at 5 km range;
Determines target azimuth and elevation with the accuracy of 0.1°, or 2 mrad, using star measurements; and
Determines the observer geo-position (longitude and latitude) both at daytime and night independently of GPS.

By integrating an eye-safe laser range finder with stabilized binocular and using celestial objects as absolute references for target azimuth and elevation determination, as well as determination of the observer geo-position (latitude and longitude) a new target localization capability can be developed. The new targeting system is battery powered, portable, light weight, and low cost.

The unit provides a new revolutionary capability for target localization, which reduces the target localization error by a factor of up to 5, and perform multiple functions, which include target coordinates determination, as well as determination of the observer geo-position independently of GPS when GPS is jammed or not available.

The basic concept of the PCS is to determine the absolute azimuth pointing of the Vector 21 (laser range finder binoculars) based on measurements of sun position, time, and geo-location. Briefly the hardware mounted on the binoculars consists of a 180 degree fisheye lens, ND filter, USB camera, and MEMS 2-axis inclinometer. The camera and inclinometer are linked to a laptop computer which is used to record raw data (images, inclinometer readings, etc) or provide “real” time calculations. The module as mounted on the Vector 21 is shown in FIG. 1. Some parameters of interest for the camera and 180 deg fisheye lens are listed in Table 1. Time is provided by synchronizing the laptop PC to NIST internet time using NIST WindowsXP software (performed once per day). Geo-location is provided by GPS (several independent measurements).

TABLE 1
Camera, fisheye lens parameters.

| | |
|---|---|
| Camera | |
| pixel size | 5.2 um |
| array size | 1024 × 1280 |
| bits/pixel | 8 |
| QE | ~typical CMOS monochrome |
| Frame rate | ~10 fps typical operation |
| Fisheye | |
| f/# | 2 |
| Horiz field of view | 185 deg |

### Outline of Basic Steps:

1) Measure sun azimuth and zenith on the fisheye where radius to center is proportional to the zenith angle and azimuth is the angle between column offset and row offset from the center.
2) Mathematically rotate azimuth and zenith angle (small angle approximation) from sensor/fisheye frame to inclinometer frame (i.e. calibrate by determining fisheye boresight when inclinometer is zeroed).
3) Mathematically rotate azimuth and zenith from inclinometer frame to local horizon frame with unknown azimuth offset.
4) Determine azimuth offset by taking difference between measured azimuth (step 3) and known sun position (from time and position).
5) Mathematically rotate boresight pointing in inclinometer coordinates to local horizon coordinates (with unknown azimuth) using inclinometer measurements
6) Determine absolute azimuth of boresight by azimuth offset determined in step (4).

Calibration procedure: Reverse steps (5) and (6) above while siting targets with known absolute azimuth.

### Detailed Equations:

Coordinate System for Sun Position Analysis.
(1) Measure sun centroid (xₛ,yₛ)
(2) Azimuth and zenith angles in sensor coordinates

$${ϕ}_{s} = {tan}^{- 1} ( \frac{{y}_{s} - {y}_{s 0}}{{x}_{s} - {x}_{s 0}} )$$

$${θ}_{s} = Δ x \sqrt{{( {x}_{s} - {x}_{s 0} )}^{2} + {( {y}_{s} - {y}_{s 0} )}^{2}}$$

(3) Rotate to optical axis

φₒ=φₛ+(βₛ sin φₛ+αₛ cos φₛ)cot θₛ

θₒ=θₛ+(−βₛ cos φₛ+αₛ sin φₛ)
(4) Rotate to local horizon using inclinometer measurements, (θₓ, θ_{y})

φₗ=φₒ−(θ_{y} sin φₒ−θₓ cos φₒ)cot θₒ

θₗ=θₒ+(θ_{y} cos φₒ+θₓ sin φₒ)

Δφₛᵤₙ=φ′ₗ−φₗ
where φ′ₗ is the absolute azimuth of the sun.
(5) Rotate boresight to local horizon coordinates

φ_{bl}=φ_{b}−(θ_{y} sin φ_{b}−θₓ cos φ_{b})cot θ_{b}

θ_{bl}=θ_{b}+(θ_{y} cos φ_{b}+θₓ sin φ_{b})

φ′_{bl}=φ_{bl}+Δφₛᵤₙ
where φ′_{bl} is the absolute azimuth of the target, and θ_{bl} is the absolute zenith angle of the target.

A brief description of variable notation is summarized in Table 2. The reader should note that all coordinate rotations are based on small angle approximations. This seems reasonable since all measurements of the optical axis offset from the inclinometer z-axis (zenith pointing for zero readings) show angles less than 10 mr. All measurements to date are on objects with inclinometer pitch and roll readings less than 5 degrees (which may start to be marginal).

TABLE 2
Parameter definitions

| | |
|---|---|
| (1) | (xₛ₀, yₛ₀) = array center in pixels on sensor |
| (2) | Δx = angular pixel size |
| (3) | (αₛ, βₛ) pitch and roll of fisheye optical axis with respect to |
| | inclinometer z-axis (zenith for leveled inclinometer) |
| (4) | (φ_{b}, θ_{b}) = azimuth and zenith angle of binocular |
| | boresight in inclinometer reference frame. |

Measured Quantities

| | |
|---|---|
| (1) | (xₛ, yₛ ) = sun centroid on sensor |
| (2) | (θₓ , θ_{y}) = inclinometer measured pitch and roll. |

Calculated Quantities

| | |
|---|---|
| (1) | (φₛ, θₛ) = measured sun azimuth and zenith angle |
| | in sensor/fisheye frame |
| (2) | (φₒ, θₒ) = measured sun azimuth and zenith angle |
| | in inclinometer frame |
| (3) | (φₗ, θₗ) = measured sun azimuth and zenith angle |
| | in module based local horizon coordinates |
| (4) | Δ_{φ}_{ₛᵤₙ} = yaw of module based local horizon coordinates |
| | relative to true local horizon coordinates (ENU). |
| (5) | φₗ′ = absolute azimuth of the sun in local horizon coordinates |
| | (ENU) calculated based on solar ephemeris, time, and |
| | geo-location |
| (6) | φ_{bl}′ = absolute azimuth of the target |

The sun position on the sensor is determine by center of mass calculation. A matched filter determines the location of the sun (not necessary simply finding the peak is sufficient). The background (+camera A/D bias) is determined as a the average of a 32×32 pixel region centered on the peak and excluding the center 16×16 pixels. A center of mass calculation is made including only those pixels in the 16×16 region with signal exceeding 5% of the peak value.

The equations assume that the image distance from the optical axis on the sensor is a linear function of the zenith angle and the additional assumptions:
1) Inclinometer axes are orthogonal. (Presumably determined by lithography/etch on MEMS since both axes on a single die).
2) Row/column axes combined with fisheye boresight constitute an orthogonal coordinate system.

### Calibration Procedures

Several parameters calibration parameters must be determined experimentally. They are listed as the first set of items (1) through (4) in Table 2. Based on small angle approximations it may be shown that the systematic error in measured azimuth resulting from errors in the array center point and off zenith fisheye boresight is given by:

$$Δ φ = ( {α}_{s} cos {φ}_{s} + {β}_{s} sin {φ}_{s} ) \frac{cos {θ}_{s}}{sin {θ}_{s}} - \frac{Δ {θ}_{c}}{{θ}_{s}} sin ( {φ}_{s} - {φ}_{c} )$$

Where Δφ is the error in the azimuth measurement, (φ_{c}, Δθ_{c}) describes the azimuth and zenith angle on the error in center position, and the remaining parameters are described in Table 2. Notice for a fixed zenith angle, errors in boresight pointing may be corrected by the errors in center location. The expression may be rewritten in terms of an effective center point and divided into sensor row and column,

$$Δ {x}_{c} = β θ \frac{cos θ}{sin θ}$$

$$Δ {y}_{c} = - α θ \frac{cos θ}{sin θ}$$

The calibration procedure takes advantage of this property by determining the center location which minimizes the azimuth error (in the least squares since) for a series of measurements at a constant (or near constant for sun) zenith angle. The procedure is repeated for several zenith angles, and the results are plotted as a function of

$$θ \frac{cos θ}{sin θ} .$$

The slope of a linear least squares fit provides the axis pitch (or roll), and the intercept provides the offset in center column (or row).

### Error Analysis

The following is an error analysis. It is based directly on the coordinate transformation equations detailed above, so can not be considered an independent check. The results are based on small value approximations. As a first approximation two axis values which add in quadrature phase (a cos x+b sin x) are simply combined in a single “average” term, and systematic errors (such as errors in determining the calibration parameters) are treated in the same manner as random errors (centroid measurement error, mechanical drift, inclinometer noise, etc).

An attempt is made to maintain consistent notation with the explanation of the coordinate transformation. For the simplified case with the inclinometer level, the variance in determining absolute azimuth is approximately:

$${σ}_{{ϕ}_{b t}^{′}}^{2} = {σ}_{{ϕ}_{b}}^{2} + {σ}_{{ϕ}_{t}^{′}}^{2} + ( {( \frac{1}{{θ}_{s}} )}^{2} + {( \frac{{\overline{α}}_{s}}{{sin}^{2} {θ}_{s} } )}^{2} ) {σ}_{{x}_{s}}^{2} + {( \frac{{\overline{α}}_{s}}{{sin}^{2} {θ}_{s}} )}^{2} ( {( \frac{Δ {x}_{e}}{Δ x} {θ}_{s} )}^{2} ) + {σ}_{{α}_{s}}^{2} {cot}^{2} {θ}_{s} + {( \frac{1}{{sin}^{2} {θ}_{s}} )}^{2} {σ}_{{θ}_{x}}^{2}$$

A brief summary of the terms is listed in Table 3.

TABLE 3
Summary of error contributions for leveled operation.

| | |
|---|---|
| (1) | σ_{φ}_{_{b}} = error in boresight azimuth calibration |
| (2) | σ_{φ}_{ₜ}_{′} = error in calculated sun location in ENU frame. Time, geo-location, and ephemeris errors are all believed to |
| | be negligible. Error for |
| (3) | α̅ₛ = average of fisheye boresight angular offset from inclinometer z-axis. |
| (4) | σₓ_{ₛ} = error in sun position on sensor (centroid accuracy based on radiometric SNR, gain variation, and image |
| | distortion). SNR contribution believed to be small (image ~3 pixels and camera gain, exposure time set to ~200 |
| | counts out of 255, noise measured < 1 bit rms). Gain variation not measured. Image distortion, especially for large |
| | zenith angles is under investigation. |
| (5) | $\frac{Δ {x}_{e}}{Δ x} = fractional error$ |
| | in pixel size (based on linear fisheye response, more generally |
| | $( \frac{Δ {x}_{e}}{Δ x} ) {θ}_{s}$ |
| | should be replaced as systematic error in measuring zenith angle). Response nonlinearly suspected problem. |
| | Correction under investigation. |
| (6) | σ_{α}_{ₛ} = error in determining fisheye boresight calibration parameters plus boresight drift (time/temperature). |
| | Fisheye boresight calibration long term repeatability under investigation. |
| (7) | σ_{θ}_{ₓ} = noise in inclinometer measurement. |

If the device is permitted to pitch and bank, there is an additional error term which is proportional to the magnitude of the pitch and/or bank of:

$$\frac{{σ}_{{ϕ}_{blin}^{′}}}{{θ}_{x}} \approx \frac{1}{{sin}^{2} {θ}_{s}} \sqrt{{σ}_{{x}_{s}}^{2} ( {( \frac{sin {θ}_{s} cos {θ}_{s}}{{θ}_{s }} )}^{2} + 1 ) + {σ}_{{α}_{s}}^{2} ( 1 + {cos}^{4} {θ}_{s} ) + {( ( \frac{Δ {x}_{e}}{Δ x} ) {θ}_{s} )}^{2}}$$

Where a contribution from the boresight zenith angle relative to inclinometer zenith has been omitted (assumed negligible). Notice this corresponds to an rms value instead of the variance shown for leveled operation. All of the error terms are the same as described in Table 3 with the exception of, σ_{θx}, the inclinometer measurement error. For pitched/banked operation, the inclinometer measurement error now includes not only noise, but any gain or nonlinearity contributions.

In addition to the error sources discussed above, the measurements will have two additional error sources. The first is the accuracy of the reference points. The second is pointing the Vector 21 (˜1.2 mr reticule diameter). Current rough estimate is that these error sources are on the order of 0.5 mr rms.

### Measurements

### Inclinometer Accuracy

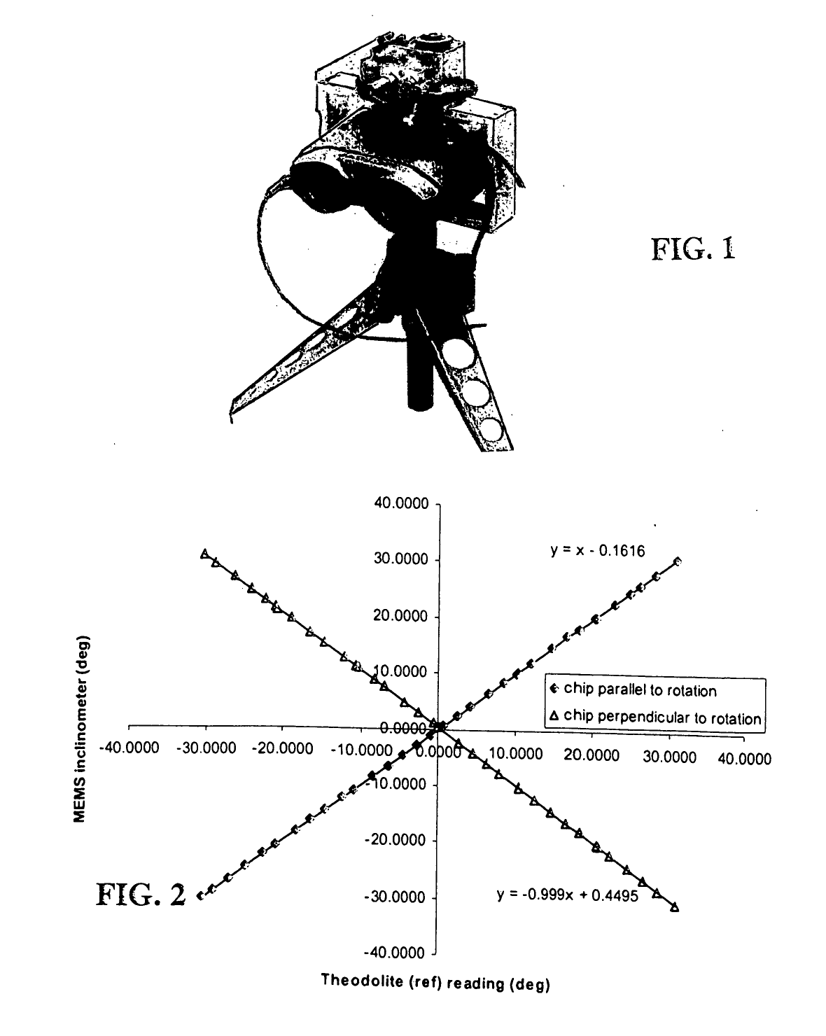

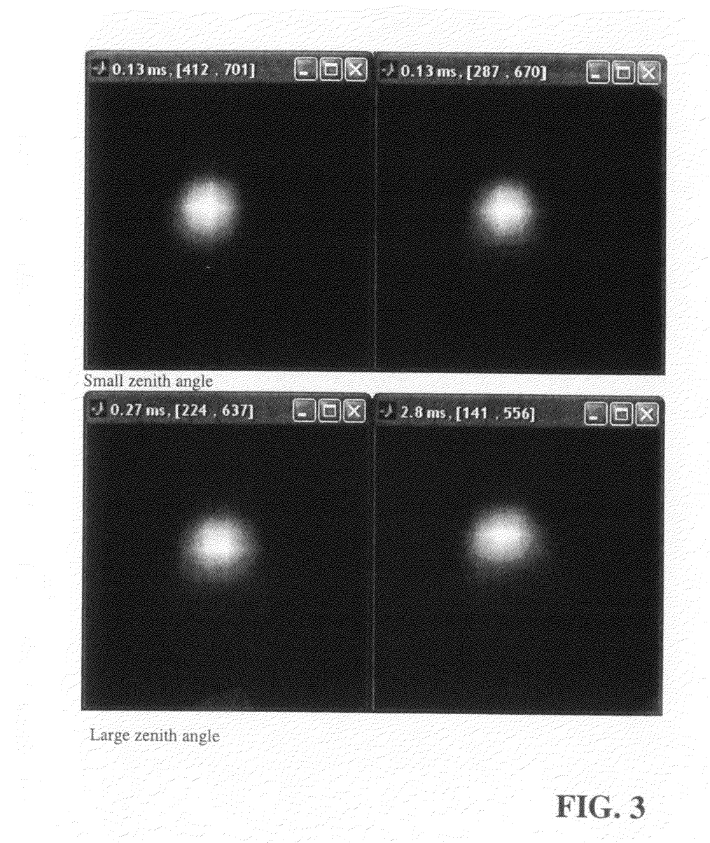

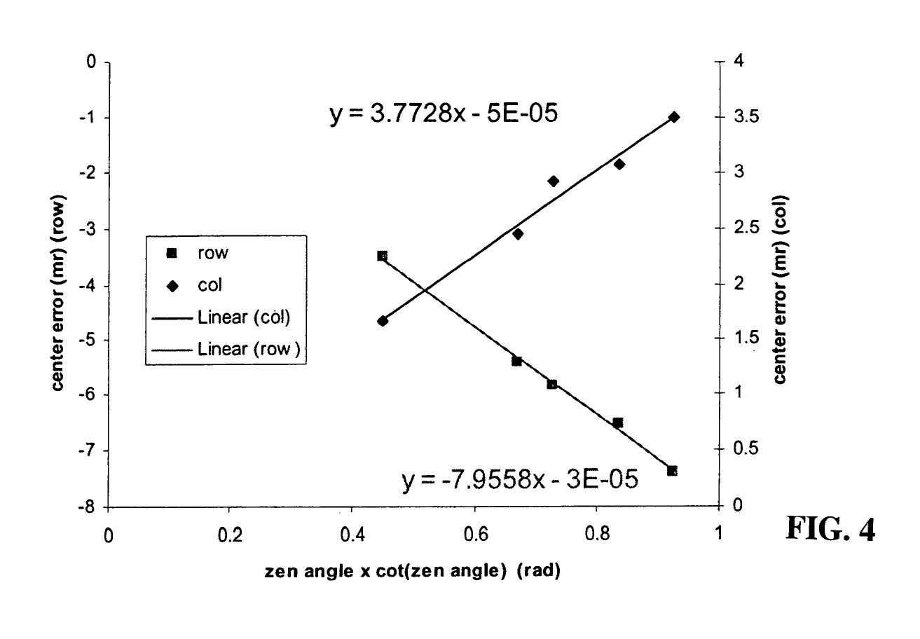

Measurements have been made to determine the deviation from linear of the MEMS inclinometer. The measurements consisted of attaching the inclinometer directly to the telescope section of a theodolite and varying simply comparing the theodolite and inclinometer measurements. The measurements (FIG. 2) indicate that the scale factor is accurate to within <1%, but the results are under review given the sensitivity of the azimuth measurement to inclinometer errors.

### Raw Images (Spot Shape Issues)

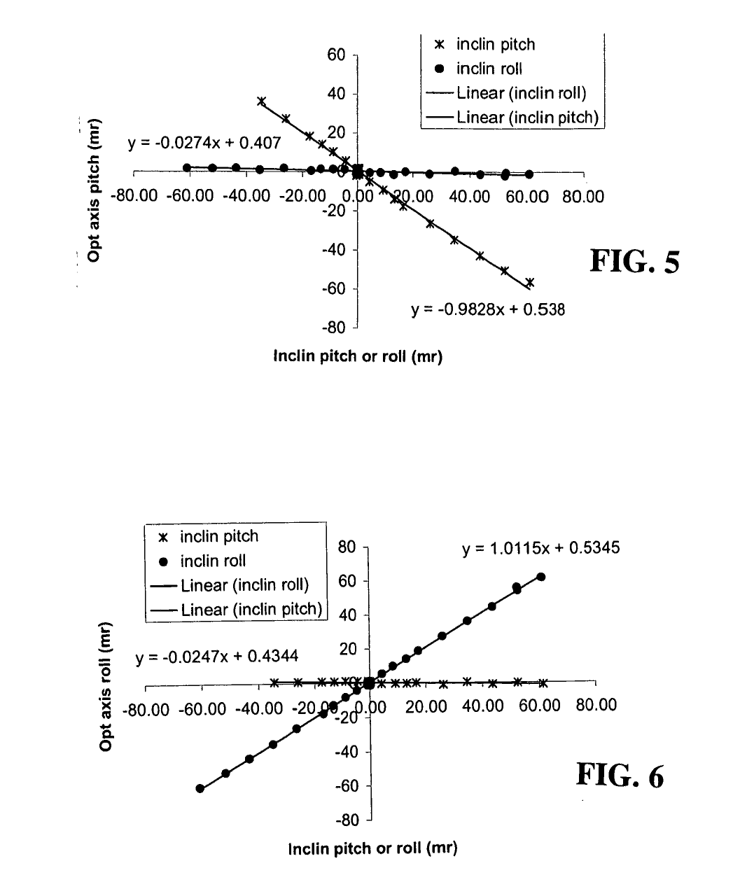

The relative alignment between the inclinometer and sensor/fisheye frames of reference was measured by viewing a collimated laser source at a fixed position and tilting the module along each of the inclinometer axes. The results are shown in FIGS. 5 and 6 for the two different axes. Notice that the results are based on 3.21 mr pixels, which is slightly different than the most recent measurement of 3.42 mr pixels. The 1% to 2% difference is currently ignored (i.e. cross terms are not included in coordinate rotation).

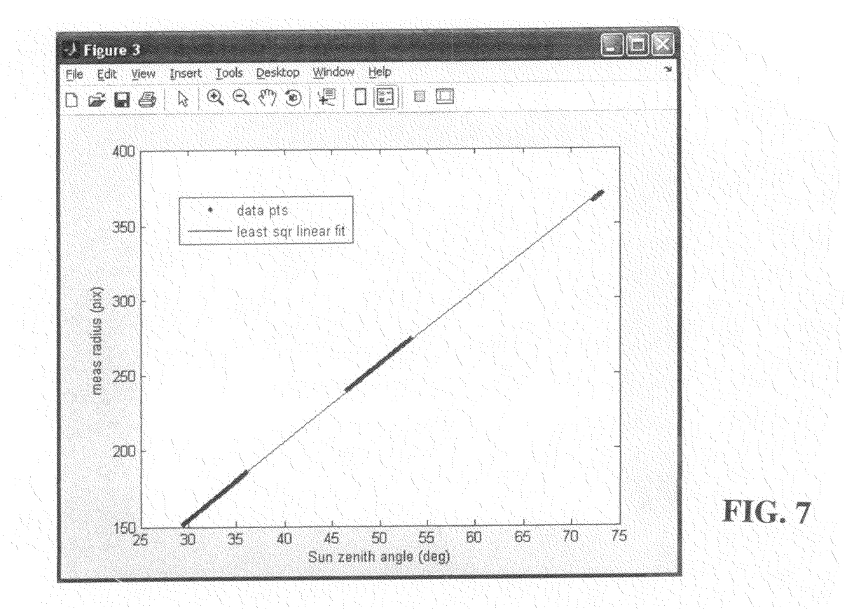

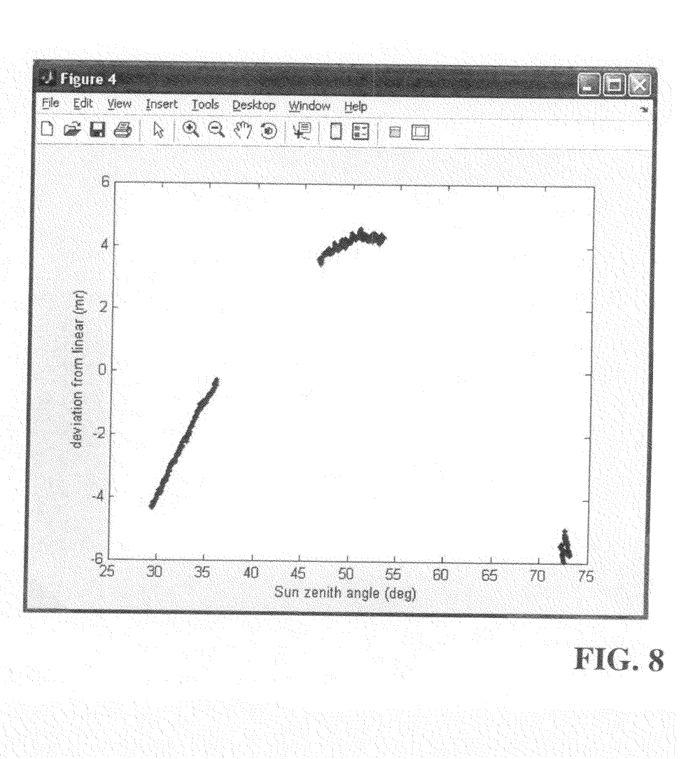

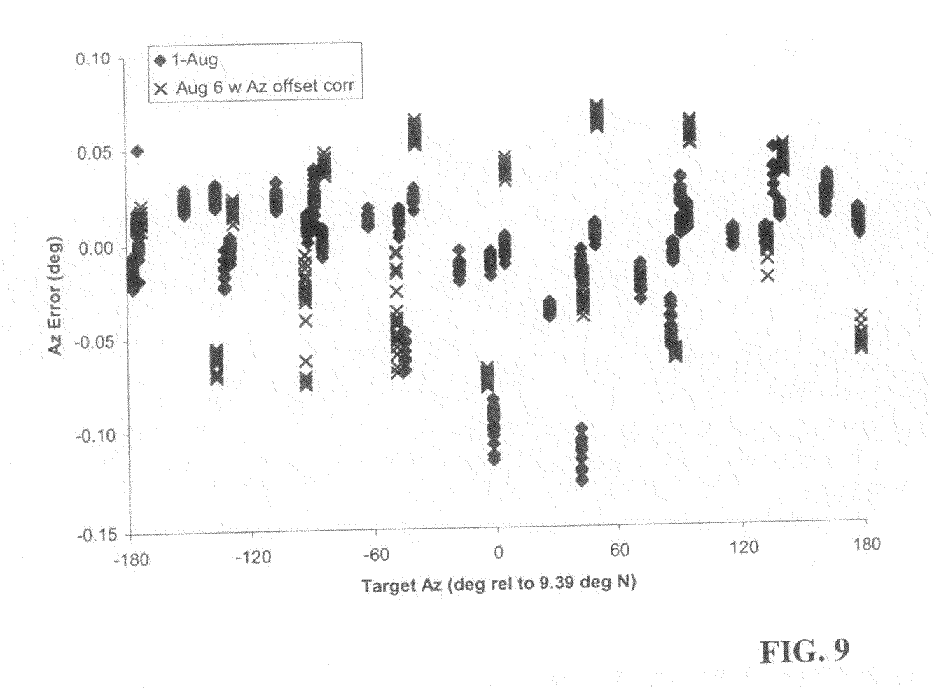

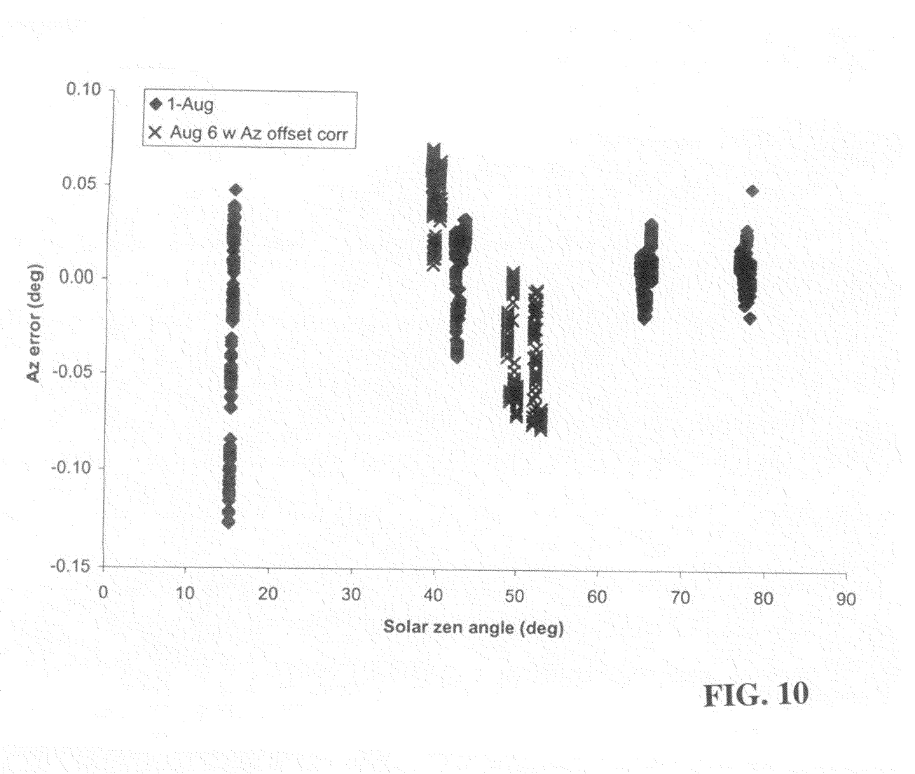

The pixel size is estimate based on the measured sun zenith angle as a function of actual sun zenith angle. The results measurement results are shown in FIG. 7 along with the resulting deviation from a least squares linear fit in FIG. 8.

### Reference Points

A list of the absolute azimuth and zenith angle for the test points used are listed in Tables 5 and 6. All reference points are based on relative angle measurements (theodolite) from a single absolute reference point. The absolute reference direction was determined based on theodolite measurements of the North star (estimated accuracy based on measurement spread of 0.5 mr rms).

TABLE 5
Reference points as viewed from LRG.

| | Abs az | Zenith | Range |
|---|---|---|---|
| Location | (deg) | (deg) | (km) |
| 1 | 7.57 | 89.14 | 1.16 |
| 2 | −39.29 | 90.4 | 0.77 |
| 3 | −39.62 | 89.06 | 0.89 |
| 4 | −39.23 | 89.59 | |
| 5 | −36.5 | 90.41 | |
| 6 | −33.21 | 90.72 | |
| 7 | −43.53 | 89.62 | 0.87 |
| 8 | 194.81 | | 0.076 |
| 9 | 175.11 | | |
| 10 | 261.05 | 89.97 | |
| 11 | −106.603 | | |
| 12 | −106.636 | | |

TABLE 6
Reference points as viewed from NOAS pt 3.

| | Abs az | Zenith | Range |
|---|---|---|---|
| Location | (deg) | (deg) | (km) |
| 1 | 9.39 | 89.12 | 1.10 |
| 2 | −42.09 | 89.58 | 0.84 |
| 3 | 39.37 | 87.98 | 10.4 |
| 4 | 39.35 | 88.05 | 10.4 |
| 5 | −118.63 | 87.10 | 1.0 |
| 6 | −4.11 | 92.06 | 0.53 |
| 7 | −5.64 | 92.22 | 0.6 |

### Measurements on the Theodolite

The module may be mounted on a standard Newport tip/tilt stage which is mounted directly to the azimuth axis of an off the shelf theodolite. The module is mounted on a custom kinematic mount on the tip/tilt stage. The tip/tilt stage may be used to level the module based on the module inclinometer. The theodolite is pointed to a reference point of known absolute azimuth to provide an absolute reference.

TABLE 7
Summary of error statistics for leveled operation.

| | Avg | Std dev | Avg | Std dev |
|---|---|---|---|---|
| date | (deg) | (deg) | (mr) | (mr) |
| 1-Aug | −0.003 | 0.032 | −0.06 | 0.56 |
| 6-Aug | 0.362 | 0.048 | 6.33 | 0.83 |
| Aug 6 w corr | −0.001 | 0.048 | −0.02 | 0.83 |

### Measurements on Vector 21

The module mounts to an aluminum frame which is secured to the ¼″-20 tripod mounting hole (and provides an offset hole for mounting to the tripod). The frame provides a custom kinematic mount to attach the module. The frame has remained attached to the Vector 21 for over all measurements and intervening time periods.

Although the present invention is described above in terms of a specific embodiment, persons skilled in the present art will recognize that there are many other possible embodiments. For example other inclinometers could be substituted for the MEMS unit. A single telescope could be substituted for the specified binoculars. Other binoculars could be used. The unit could be handheld instead of mounted on a tripod as in FIG. 1. Therefore the scope of the invention should be determined by the appended claims and their legal equivalents.

What is claimed is:

1. A portable celestial compass for determining the absolute position of a target comprising:
A) a telescope device for viewing the target
B) a 180 degree fisheye lens, a digital camera, and an inclinometer all mounted on the telescope device;
C) a GPS device for determining position of the portable celestial compass;
D) a laser rangefinder integrated adapted to determine distance to the target allows the observer to measure the target range; and
E) a computer processor programmed with software adapted to determine the azimuthal direction of a celestial object based on its celestial position determined from image data from said digital camera at a specific time and to use that information along with inclinometer reading data and the position of the portable celestial compass to determine the azimuthal position of the target and to use the azimuthal position and the target range to determine the position of the target.

2. The compass as in claim 1 and further comprising an ND filter mounted on the telescope device.

3. The compass as in claim 1 wherein the telescope is a pair of binoculars.

4. The compass as in claim 2 wherein the pair of binoculars is the US Army's M-25 stabilized binoculars.

5. The compass as in claim 1 wherein the inclinometer is a MEMS inclinometer.

6. The compass as in claim 1 wherein the camera is adapted to image the position of the sun.

7. The compass as in claim 1 wherein the camera is adapted to image the position of the moon.

8. The compass as in claim 1 wherein the camera is adapted to image the position of one or more stars.

9. The compass as in claim 1 wherein time is provided by synchronizing the laptop computer to NIST Internet time using NIST Windows XP software.

10. The compass as in claim 1 wherein said compass is mounted on a tripod.

11. The compass as in claim 1 wherein said compass is handheld
